(19) United States
(12) Patent Application Publication
(10) Pub. No.: US 2026/0138610 A1
(43) Pub. Date: May 21, 2026

(54) DEVICE AND METHOD FOR OPERATING A VEHICLE

(71) Applicant: DAIMLER TRUCK AG, Leinfelden-Echterdingen (DE)

(72) Inventor: Fridtjof STEIN, Ostfildern (DE)

(21) Appl. No.: 19/119,489

(22) PCT Filed: Jul. 26, 2023
(86) PCT No.: PCT/EP2023/070700

§ 371 Date: Apr. 9, 2025

(30) Foreign Application Priority Data
Oct. 10, 2022 (DE) 10 2022 126 231.6

(51) Int. Cl. B60W 30/18; B60R 11/04; G01C 11/30

(52) U.S. Cl. CPC B60W 30/18163; B60R 11/04; G01C 11/30; B60W 2300/14; B60W 2420/403; B60W 2420/408; B60W 2520/22

(57) ABSTRACT

A device for operating a vehicle having a tractor unit and at least one semitrailer or trailer is provided. The device includes a left camera on a left side of the tractor unit and a right camera on a right side of the tractor unit, the frustum of which in each case is directed counter to a direction of travel and overlaps the frustum of the respective other camera. A base width of the cameras is greater or can be set to be greater than a width of the semitrailer or trailer. The device is configured to survey a stereo measurement area, captured by the two cameras, based on image data from the cameras by triangulation. The device is configured to plan a lane change of the vehicle and to execute it by activating actuators of the vehicle if a traffic situation in the captured stereo measurement area permits this.

### BACKGROUND AND SUMMARY OF THE INVENTION

Exemplary embodiments of the invention relate to a device for operating a vehicle and to a method for operating a vehicle.

For the autonomous driving of vehicles, for example commercial vehicles, it is essential that the surroundings are perceived and surveyed. Sensors such as lidar, camera, radar and ultrasound are typically used for this.

A big challenge for autonomous commercial vehicles is lane changes or merging in. To do this, at least one camera needs to look to the rear to ascertain whether a target lane is free for a lane change. This is made difficult by one or more trailers and/or semitrailers of the commercial vehicle obscuring the camera's field of view.

The distance towards the rear to be monitored by the cameras depends on the traffic situation. When changing lanes in rolling traffic, the area to be monitored is relatively small. By contrast, when merging from a slip road onto a motorway at a low initial speed, the maximum distance in the area to be monitored is large. The exact area depends in this case on the maximum acceleration of the ego vehicle, which also depends on the load, and the maximum speed of other road users. Commercial vehicles often accelerate relatively slowly, so it takes them a relatively long time to reach the speed of the flowing traffic and therefore be able to merge into the traffic without impeding or endangering it.

EP 2 555 178 B1 describes a method for recording objects to the side of a commercial vehicle, wherein at least the following steps are implemented:
objects in a sector to one side of a commercial vehicle are recorded using at least one camera;
the recorded objects are assessed in an evaluation unit, wherein a position of the recorded objects relative to the commercial vehicle is ascertained and a risk of a collision with the commercial vehicle is assessed; and
in the event of a risk of a collision, the evaluation unit transmits information to a reproduction unit, in response to which the reproduction unit outputs a warning signal.

Also described is a commercial vehicle having a recording system for performing the method, wherein the recording system has at least one camera, which can be arranged on a side of the commercial vehicle, as well as an evaluation unit and at least one reproduction unit. With this method, the driver of a commercial vehicle is relieved of the task of assessing the relevance of objects.

Exemplary embodiments of the invention are directed to a novel device for operating a vehicle and a novel method for operating a vehicle.

A device according to the invention for operating a vehicle, in particular a commercial vehicle, comprising a tractor unit and at least one semitrailer or trailer, comprises a left camera on a left side of the tractor unit and a right camera on a right side of the tractor unit, the frustum of which in each case is directed counter to a direction of travel and overlaps the frustum of the respective other camera, wherein a base width of the camera is greater or can be set to be greater than a width of the semitrailer or trailer, wherein the device is configured to survey a stereo measurement area, captured by the two cameras, on the basis of image data from the camera by means of triangulation. According to the invention, the device is configured to plan a lane change of the vehicle and to execute it by activating actuators of the vehicle if a traffic situation in the captured stereo measurement area permits this. It is advantageous to select the base width to be as wide as possible.

By arranging a camera to the left of the driver's cab and a camera to the right of the driver's cab, the best possible monitoring of the traffic area to the rear is made possible, since otherwise this would be obscured by the vehicle combination itself and the corresponding left-hand and/or right-hand bends would not be visible. Approaches that are based on a mono-camera cannot use a physical measuring principle such as triangulation for measuring distances, since these approaches are merely able to estimate distances using assumptions and semantic analysis (such as deep learning), which are correspondingly prone to error.

The commercial vehicle, in particular the semitrailer or trailer, creates a blind spot for both cameras by obscuring them. Depending on a respective lateral spacing of the cameras from the semitrailer, the area of the blind spot becomes smaller and there is a stereo measurement area visible to the two cameras. This makes it possible to survey the stereo measurement area by means of stereo triangulation.

In one embodiment, the cameras are arranged on the tractor unit fixedly or at least such that they can be extended as required, for example in each case by means of motorized extendible mounts. If the cameras can be extended, then the surveying can be improved further as a result of the base width being enlarged. Such an extending of the cameras is also temporarily possible, in particular when surveying is required.

In one embodiment, the cameras are designed to receive light in the visible wavelength range and/or in the infrared range. The latter option is an advantage in particular at night.

In one embodiment, the base width is more than 3 m or can be set to more than 3 m by extending the cameras. Due to a large base width of, for example, more than 3 m, particularly relevant values can be ascertained metrologically.

In one embodiment, at least one further sensor, which is designed as a radar sensor and/or as a lidar sensor, is provided to observe the surroundings behind the vehicle, wherein the device is configured to consolidate image data from the camera with data from the at least one further sensor and use this as a basis for the planning and execution of lane changes.

In accordance with one aspect of the present invention, a method is proposed for operating a vehicle, in particular a commercial vehicle, in particular by means of the above-described device, wherein the vehicle has a tractor unit and at least one semitrailer or trailer, wherein a left camera is provided on a left side of the tractor unit and a right camera is provided on a right side of the tractor unit, the frustum of which in each case is directed counter to a direction of travel and overlaps the frustum of the respective other camera, wherein a base width of the cameras is greater or is set to be greater than a width of the semitrailer or trailer, wherein a stereo measurement area, captured by the two cameras, is surveyed on the basis of image data from the cameras by means of triangulation, wherein lane changes of the vehicle are planned and executed by activating actuators of the vehicle if a traffic situation in the captured stereo measurement area permits this.

In one embodiment, a maximum extended width of the left camera and a maximum extended width of the right camera are determined and set based on a driving situation and a true speed of the vehicle. Based on the extended widths and the known width of the semitrailer or trailer, the base width is updated for the purpose of calculating the triangulation.

In one embodiment, an angle is determined by which the semitrailer or trailer is pivoted relative to a longitudinal axis of the tractor unit, wherein the triangulation is performed if the absolute value of the angle is less than a specified minimum pivot angle. Otherwise, in particular, triangulation and/or a lane change will not be performed

In one embodiment, to assess whether the traffic situation permits a lane change, approaching objects, their distance from the vehicle and their trajectory relative to the vehicle are ascertained in the stereo measurement area. In one embodiment, a relative speed between the vehicle and the approaching object is also estimated and taken into account.

Where the present application talks about lane changes, this can mean both the merging in of a vehicle from an acceleration lane onto an actual traffic route as well as the normal switching of the vehicle between lanes on a multilane carriageway.

The approach according to the solution described herein can be applied not only to commercial vehicle combinations, but also to other vehicles, for example cars, car-trailer combinations, pickup trucks or buses, in particular articulated buses.

### BRIEF DESCRIPTION OF THE DRAWING FIGURES

Exemplary embodiments of the invention are explained in more detail hereinafter with reference to drawings, in which:

FIG. 1 shows a schematic detailed view of a commercial vehicle, comprising a tractor unit and a semitrailer,

FIG. 2 shows a schematic view of the commercial vehicle, wherein the semitrailer is in straight alignment with the tractor unit,

FIG. 3 shows a schematic view of the commercial vehicle, wherein the semitrailer is not in straight alignment with the tractor unit,

FIG. 4 shows a schematic view of the semitrailer with a stereo measurement area of the cameras and a blind spot, wherein the semitrailer is in straight alignment with the tractor unit,

FIG. 5 shows a schematic diagram to illustrate the relationship between the length x and the lateral spacing of the camera from the semitrailer,

FIG. 6 shows a schematic view of the semitrailer with a stereo measurement area of the cameras and a blind spot, wherein the semitrailer is not in straight alignment with the tractor unit,

FIG. 7 shows a further schematic view of the semitrailer in the situation from FIG. 6,

FIG. 8 shows a schematic view of a device for assessing a traffic situation behind the commercial vehicle.

Parts that correspond to each other are provided with the same reference numerals throughout the figures.

### DETAILED DESCRIPTION

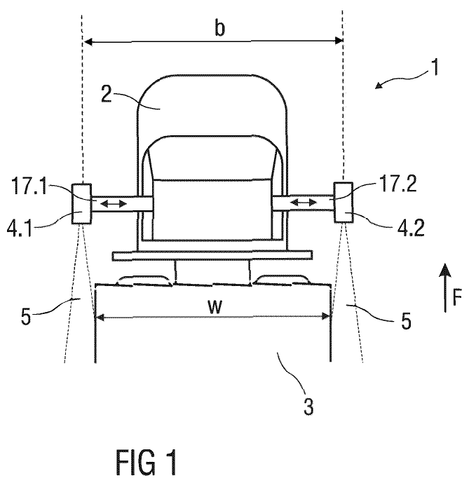

FIG. 1 is a schematic detailed view of a vehicle 1, in particular commercial vehicle 1, comprising a tractor unit 2 and a semitrailer 3. In other exemplary embodiments, at least one trailer can be provided instead of the semitrailer 3.

A camera 4.1, 4.2 is arranged in each case on a left side and on a right side of the tractor unit 2, the frustum 5 of which camera is directed counter to a direction of travel F, i.e., towards the rear.

The cameras 4.1, 4.2 can be arranged on the tractor unit 2 fixedly or such that they can be extended, for example in each case by means of a fixed or extendible mount 17.1, 17.2.

The cameras 4.1, 4.2 can be designed to receive light in the visible wavelength range and/or in the infrared range (thermal imaging camera). The latter option is an advantage at night.

A base width b of the cameras 4.1, 4.2, i.e., how far apart they are spaced from each other, must be greater than a width w of the semitrailer 3 or the trailer. It is advantageous to select the largest possible base width b.

By arranging a camera 4.1 to the left of the driver's cab and a camera 4.2 to the right of the driver's cab, the best possible monitoring of the traffic area to the rear is made possible, since otherwise this area would be obscured by the vehicle combination itself and the corresponding left-hand and/or right-hand bends would not be visible. Approaches that are based on a mono-camera cannot use a physical measuring principle such as triangulation for measuring distances, since these approaches are merely able to estimate distances using assumptions and semantic analysis (such as deep learning), which are correspondingly prone to error.

The commercial vehicle 1 (combination), in particular the semitrailer 3 or trailer, creates a blind spot 7 for both cameras 4.1, 4.2 by obscuring them. Depending on a respective lateral spacing a of the cameras 4.1, 4.2 from the semitrailer 3, the area of the blind spot 7 becomes smaller and there is a stereo measurement area 6, visible to the two cameras 4.1, 4.2. This makes it possible to survey the stereo measurement area 6 by means of stereo triangulation. Due to a large base width b of, for example, more than 3 m, particularly relevant values can be ascertained metrologically.

If the cameras 4.1, 4.2 can also be extended then the surveying can be improved further. Such an extending of the cameras 4.1, 4.2 is also temporarily possible, in particular when surveying is required.

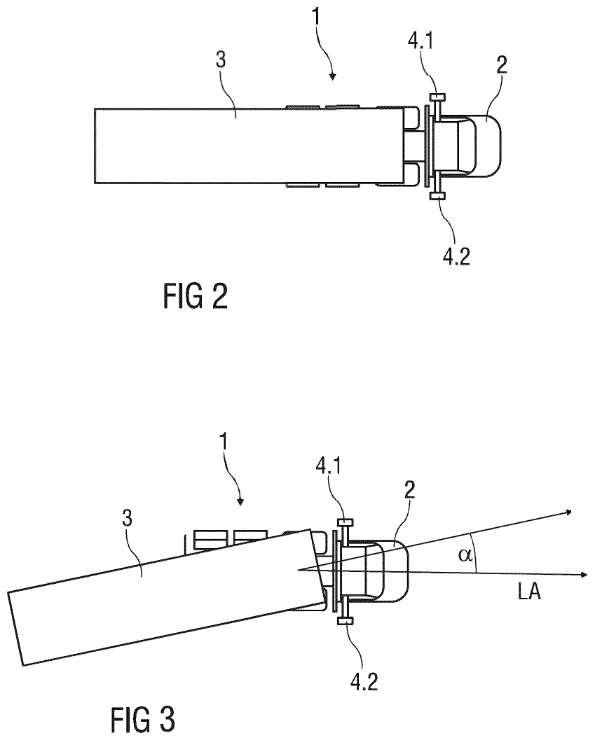

FIG. 2 is a schematic view of the commercial vehicle 1, wherein the semitrailer 3 is in straight alignment with the tractor unit 2. FIG. 3 is a schematic view of the commercial vehicle 1, wherein the semitrailer 3 is not in straight alignment, i.e. at an angle α, with a longitudinal axis LA of the tractor unit 2. This angle α is not equal to zero.

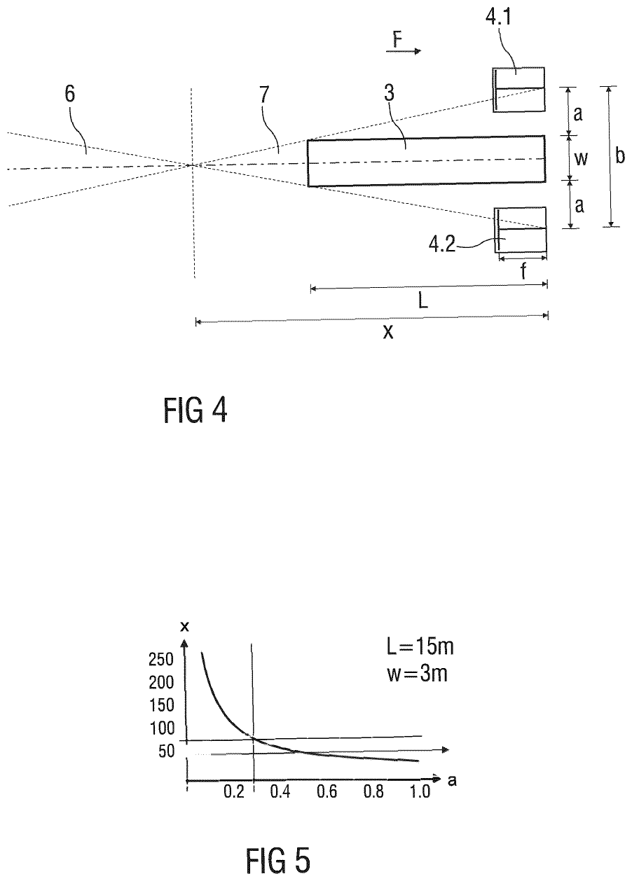

FIG. 4 is a schematic view of the semitrailer 3 with a stereo measurement area 6 of the cameras 4.1, 4.2 and a blind spot 7, wherein the semitrailer 3 is in straight alignment with the tractor unit 2. The base width b corresponds to the sum of the width w of the semitrailer 3 and the respective lateral spacings a of the cameras 4.1, 4.2 from the semitrailer 3. The blind spot 7 arises as a result of the frustum 5 being obscured by the semitrailer 3 and begins at that end of the latter that is the rear end in relation to the direction of travel F. The blind spot 7 ends at a length x behind the semitrailer 3 that starts from a front end, in relation to the direction of travel F, of the semitrailer 3. The following relationships apply in this case:

$$\frac{x}{x - L} = \frac{a + \frac{w}{2}}{\frac{w}{2}} ,$$

$$x = \frac{L w}{2 a} + L ,$$

where L is the length of the semitrailer 3.

The stereo measurement area 6 begins at the length x and continues counter to the direction of travel F.

FIG. 5 is a schematic diagram to illustrate the relationship between the length x and the lateral spacing a of the cameras 4.1, 4.2 from the semitrailer 3. The full width of a lane in which the commercial vehicle 1 is driving can be seen at a length x₂≈2.

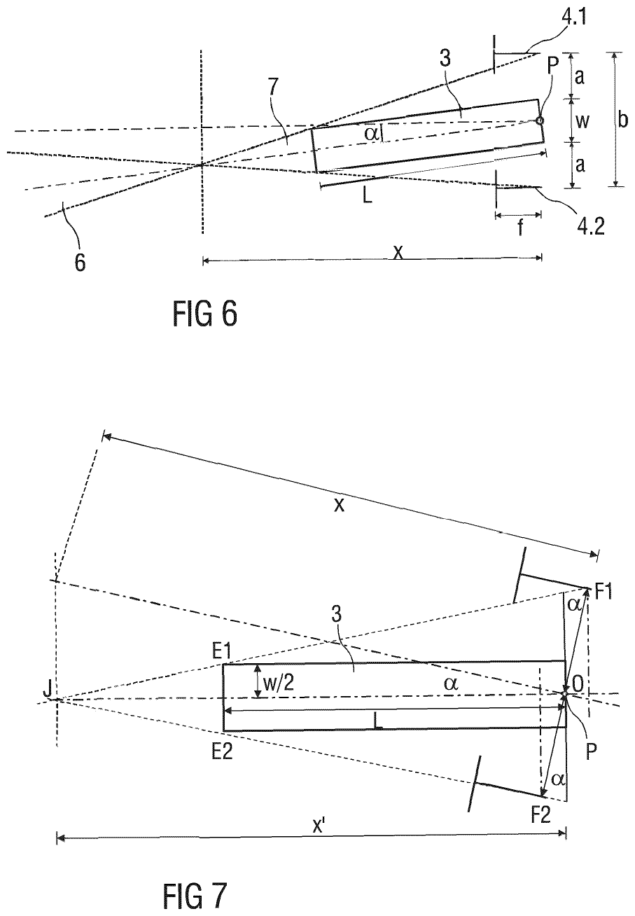

FIG. 6 is a schematic view of the semitrailer 3 with a stereo measurement area 6 of the cameras 4.1, 4.2 and a blind spot 7, wherein the semitrailer 3 is not in straight alignment, i.e., at an angle ∝≠0, with the tractor unit 2. FIG. 7 is a further schematic view of the semitrailer 3 in this situation. The base width b corresponds to the sum of the width w of the semitrailer 3 and the respective lateral spacings a of the cameras 4.1, 4.2 from the semitrailer 3 at a point P, for example a kingpin, about which it pivots relative to the tractor unit 2. The blind spot 7 arises as a result of the frustum 5 being obscured by the semitrailer 3 and begins at the end of the latter that is the rear end in relation to the direction of travel F. Starting from a front end, in relation to the direction of travel F, of the semitrailer 3, the blind spot 7 ends at a length x behind the semitrailer 3 in the extension of a longitudinal axis LA of the tractor unit 2. The following relationships apply in this case:

$$q = a + w / 2 ,$$

$$E 1 = ( L , w / 2 ) ,$$

$$E 2 = L , - w / 2 ) ,$$

$$J = ( {x}^{′} , 0 ) ,$$

$$F 1 = ( - sin ( α ) , cos ( α ) ) \cdot q ,$$

$$F 2 = ( + sin ( α ) , cos ( α ) ) \cdot q ,$$

$$x = cos ( α ) \cdot {x}^{′} ,$$

where q is an auxiliary parameter, E1 and E2 represent the rear corners of the semitrailer 3 or trailer, J represents an intersection point as start point of the stereo measurement area, F1 is the focal point of the camera 4.1, F2 is the focal point of the camera 4.2, and x′ is the distance of the start of the stereo measurement area along the axis of the semitrailer 3 or trailer. The focal length of the cameras is symbolized with the reference numeral f.

In the case of larger angles α, it is possible that the stereo measurement area 6 does not overlap with the desired road section to be monitored.

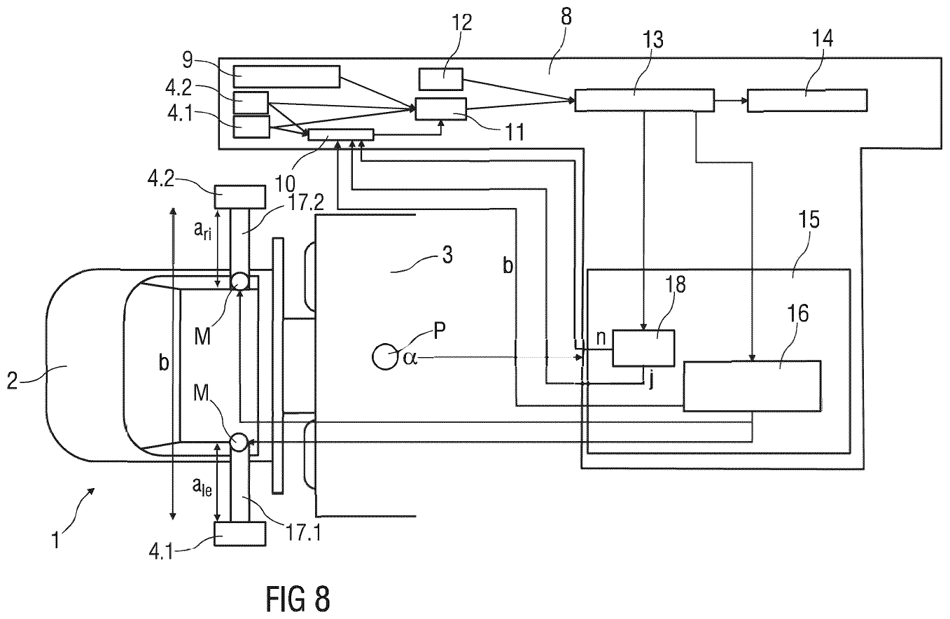

FIG. 8 is a schematic view of a device 8 for assessing a traffic situation behind the commercial vehicle 1.

The device 8 comprises the left camera 4.1, the right camera 4.2 and optionally at least one further sensor 9 to observe the surroundings behind the commercial vehicle 1, for example at least one radar sensor and/or at least one lidar sensor. Data obtained from the cameras 4.1, 4.2 are processed in a stereo image module 10 to create a stereo image of the traffic situation behind the commercial vehicle 1, for example by means of triangulation. A fusion module 11 is optionally provided, which processes the stereo image with data from the further sensors 9 to form a consolidated image of the traffic situation behind the commercial vehicle 1. This image, together with data from a digital map 12, is supplied to a behavior and planning module 13. The behavior and planning module 13 plans lane changes of the commercial vehicle 1 and activates an actuator control system 14 configured to activate actuators of the commercial vehicle 1 to execute this lane change. Furthermore, the behavior and planning module 13 is coupled to a rearward stereo module 15 which has a calculation unit 16 for calculating a maximum extended width aₗₑ of the left camera 4.1 and a maximum extended width aᵣᵢ of the right camera 4.2 based on a driving situation and a true speed of the commercial vehicle 1. The calculation unit 16 informs the stereo image module 10 of the current base width b that it needs to calculate the stereo image, based on the extended widths aₗₑ and aᵣᵢ and the known width w of the semitrailer 3. In the process, the stereo image module 10 is informed of the current base width b constantly or periodically for example. Furthermore, the calculation unit 16 controls motorized extendible mounts 17.1, 17.2 of the cameras 4.1, 4.2 in order to set the extended widths aₗₑ and aᵣᵢ.

Following the surveying request, provision can be made for the motorized extendible mounts 17.1, 17.2 to be retracted again.

Furthermore, the rearward stereo module 15 has an angle determining unit 18 for determining the angle α by which the semitrailer 3 is pivoted relative to the longitudinal axis LA of the tractor unit 2 about the point P when the behavior and planning module 13 issues a request to the rear stereo module 15 to carry out a rearward distance survey. If the absolute value of the angle α is less than a maximum pivot angle αₘₐₓ, then the stereo image module 10 is activated. If this is not the case, then the stereo image module 10 is deactivated.

By means of the proposed solution, the rear traffic situation can be surveyed at a distance of, for example, up to 300 m or more. As further sensors 9, lidars and/or radars can be used for support and consolidation purposes.

The proposed solution is the equivalent of a look-over-the-shoulder, which involves looking back far enough to estimate a distance of an approaching object before merging in and/or changing lane. Ideally, the relative speed between the ego vehicle and the approaching object should also be estimated. To this end, a radar sensor is particularly suitable, however the use of lidar sensors is also possible for this purpose. Furthermore, it should be determined in which lane the approaching object is travelling and whether this is relevant for the planned lane change.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 vehicle, commercial vehicle
2 tractor unit
3 semitrailer
4.1 camera, left camera
4.2 camera, right camera
frustum
6 stereo measurement area
7 blind spot
8 device
9 further sensor
stereo image module
11 fusion module
12 digital map
13 behavior and planning module
14 actuator control system
rearward stereo module
16 calculation unit
17.1 mount
17.2 mount
18 angle determining unit
a lateral spacing of the camera
αₗₑ maximum extended width
αₘᵢₙ minimum pivot angle
αᵣᵢ maximum extended width
b base width
f focal length
E1 rear corner
E2 rear corner
F direction of travel
F1 focal point the camera 4.1
F2 focal point the camera 4.2
J intersection point
L length
LA longitudinal axis
P point
w width
x length
x′ distance
α angle

1-10. (canceled)

11. A device for operating a vehicle, wherein the vehicle comprises a tractor unit and at least one semitrailer or trailer, wherein the device comprises:
a left camera on a left side of the tractor unit; and
a right camera on a right side of the tractor unit, wherein a frustum of the left and right cameras is directed counter to a direction of travel of the vehicle, wherein the frustrum of the left camera overlaps the frustum of the right camera, wherein a base width of the left and right cameras is greater than or is settable to be greater than a width of the semitrailer or trailer,
wherein the device is configured to survey, by triangulation, a stereo measurement area captured by the left and right cameras, based on image data from the left and right cameras, and
wherein the device is configured to plan a lane change of the vehicle and to execute the lane change by activating actuators of the vehicle when a traffic situation in the captured stereo measurement area permits the lane change.

12. The device of claim 11, wherein the left and right cameras are arranged on the tractor unit fixedly or at least such that the left and right cameras are extendable as required.

13. The device of claim 11, wherein the left and right cameras are configured to receive light in a visible wavelength range or in an infrared range.

14. The device of claim 11, wherein the base width is more than 3 meters or is settable to more than 3 meters by extending the left and right cameras.

15. The device of claim 11, further comprising:
at least one further sensor, which is a radar sensor or a lidar sensor, wherein the at least one further sensor is configured to observe surroundings behind the vehicle, wherein the device is configured to consolidate image data from the left and right cameras with data from the at least one further sensor and to use the consolidated image data as a basis for the planning and execution of the lane change.

16. A method for operating a vehicle, wherein the vehicle comprises a tractor unit and at least one semitrailer or trailer, wherein the method comprises:
capturing, by a left camera on a left side of the tractor unit, first image data;
capturing, by a right camera on a right side of the tractor unit, second image data wherein a frustum of the left and right cameras is directed counter to a direction of travel of the vehicle, wherein the frustrum of the left camera overlaps the frustum of the right camera, wherein a base width of the left and right cameras is greater than or is settable to be greater than a width of the semitrailer or trailer;
surveying, by a device of the vehicle using triangulation, a stereo measurement area (6) captured by the left and right cameras, based on the first and second image from the left and right cameras, respectively; and
planning, by the device, a lane change of the vehicle; and
executing, by the device, the lane change by activating actuators of the vehicle when a traffic situation in the captured stereo measurement area permits the lane change.

17. The method of claim 16, further comprising:
determining and setting a maximum extended width of the left camera and a maximum extended width of the right camera based on a driving situation and a true speed of the vehicle; and
updating, based on the maximum extended widths of the left and right cameras and a known width of the semitrailer or trailer, the base width (b) for the triangulation.

18. The method of claim 16, further comprising:
determining an angle by which the semitrailer or trailer is pivoted relative to a longitudinal axis of the tractor unit, wherein the triangulation is performed if an absolute value of the angle is less than a specified minimum pivot angle.

19. The method of claim 16, wherein to assess whether the traffic situation permits a lane change, approaching objects, distances of the approaching objects from the vehicle, and a trajectory of the approaching objects relative to the vehicle are determined in the stereo measurement area.

20. The method of claim 19, wherein a relative speed between the vehicle and the approaching objects is also estimated.
